(19) United States
(12) Patent Application Publication
(10) Pub. No.: US 2010/0060774 A1
(43) Pub. Date: Mar. 11, 2010

(54) LENS DRIVE DEVICE

(75) Inventors: Takahiro Azuma, Nagano (JP); Ritsuko Tahara, Nagano (JP); Takeshi Sue, Nagano (JP); Akihito Wada, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/280,682

(22) PCT Filed: Feb. 23, 2007
(86) PCT No.: PCT/JP2007/053373

§ 371 Date: Jan. 26, 2009

(30) Foreign Application Priority Data
Feb. 24, 2006 (JP) JP 2006-048497
Mar. 30, 2006 (JP) JP 2006-093351

(51) Int. Cl. H04N 5/225

(52) U.S. Cl. 348/335; 348/E05.024

(57) ABSTRACT

A lens drive device may include a movable lens body provided with a lens and a drive mechanism for moving the movable lens body in an optical axis direction of the lens. The drive mechanism may include a drive coil, a magnet comprised of a plurality of magnet pieces, and a holder body which holds the magnet. The magnet may be disposed so that predetermined gap spaces are formed between opposite end faces of the plurality of magnet pieces, and the respective magnet pieces may be adhesively bonded and fixed to the holder body by using a first adhesive means, and a second adhesive means may be disposed in the gap spaces and between the end faces of the magnet pieces.

### CROSS REFERENCE TO RELATED APPLICATIONS

This is a U.S. national stage of application No. PCT/JP2007/053373, filed on Feb. 23, 2007. Priority under 35 U.S.C. § 119(a) and 35 U.S.C. § 365(b) is claimed from Japanese Application No. 2006-048497, filed Feb. 24, 2006 and Japanese Patent Application No. 2006-093351, filed Mar. 30, 2006, the disclosures of which are also incorporated herein by reference.

### FIELD OF THE INVENTION

The present invention relates to a lens drive device.

### BACKGROUND

A lens drive device in which a lens is driven to move in an optical axis direction for forming an image of an object to be photographed is mounted on a portable device such as a digital camera and a cellular phone with a camera. For example, a lens drive device has been proposed which includes a movable lens body provided with a lens and a fixed body for moving the movable lens body along an optical axis of the lens. The movable lens body is moved in the optical axis direction of the lens by a magnetic circuit comprised of a magnet and a drive coil (see Patent Reference 1).

In the lens drive device described in Patent Reference 1, a magnet is fixed on an outer periphery of a lens holder structuring the movable lens body with an adhesive. Specifically, after a ring-shaped magnet has been fitted on the outer periphery of a lens holder, an adhesive is injected into a gap space between an inner peripheral face of the magnet and the outer peripheral face of the lens holder. After that, the adhesive is hardened to fix the magnet to the lens holder.

[Patent Reference 1] Japanese Patent Laid-Open No. 2004-184779

### SUMMARY OF THE INVENTION

However, in the fixing method for the magnet which is described above, a fixed strength of the magnet to the lens holder is not sufficient and, when an impact test is performed, the magnet may be dropped off.

In addition, in recent years, a size of the lens drive device itself has been reduced and thus the size of the magnet is also required to reduce. Therefore, an adhesive area becomes small and an adhesive strength becomes low.

In view of the problems described above, at least an embodiment of the present invention provides a lens drive device in which a magnet structuring a drive mechanism is capable of being fixed with a sufficient fixing strength.

In order to solve the problems described above, at least an embodiment of the present invention provides the following.

In order to solve the problems, according to at least an embodiment of the present invention, there is provided a lens drive device including a movable lens body which is provided with a lens, and a drive mechanism for moving the movable lens body in an optical axis direction of the lens. The drive mechanism includes a drive coil, a magnet comprised of a plurality of magnet pieces, and a holder body which holds the magnet. The magnet is disposed so that predetermined gap spaces are formed between opposite end faces of a plurality of the magnet pieces, and the respective magnet pieces are adhesively bonded and fixed to the holder body by using a first adhesive means, and a second adhesive means is disposed in the gap space and on the end faces of the magnet pieces.

According to at least an embodiment of the present invention, the holder body for holding the magnet pieces and the magnet pieces are fixed to each other by the first adhesive means and the second adhesive means is disposed in the gap space, which is formed between the opposite end faces of the magnet pieces, and on the opposite end faces of the magnet pieces and thus fixing strength of the magnet is improved and falling of the magnet can be prevented.

In at least an embodiment of the present invention, it is preferable that the second adhesive means is hardened in a fillet-shape. According to at least an embodiment of the present invention, the second adhesive means is hardened in a fillet-shape so as to bridge between the magnet pieces in the gap space. Therefore, the second adhesive means functions as impact absorption material and falling of the magnet can be prevented.

It is preferable that Shore D hardness of the second adhesive means is 70 or less. According to at least an embodiment of the present invention, since the Shore D hardness of the second adhesive means is 70 or less, even when an impact is applied to the magnet pieces, the impact can be further absorbed and thus falling of the magnet from the holder body can be prevented.

In addition, it is preferable that the second adhesive means is silicon gel. According to at least an embodiment of the present invention, since the second adhesive means is silicon gel, even when an impact is applied to the magnet pieces, the impact can be further absorbed.

Further, it is preferable that the second adhesive means is an adhesive which is hardened by visible light or UV light. According to at least an embodiment of the present invention, the shape of the second adhesive means is fixed by being hardened by visible light or UV light. Therefore, the shape of the adhesive at the time of being coated and the shape of the adhesive at the time of being hardened are the same and thus the shape at the time of being coated so that an impact is easily absorbed can be maintained after having been hardened.

In at least an embodiment of the present invention, it is preferable that the holder body includes at least one flat face and the magnet is formed in a shape along an inner peripheral shape of the holder body. According to at least an embodiment of the present invention, the magnet is also arranged in a space which is formed between the holder body including at least one flat face and the movable lens body which is accommodated in the holder body. Therefore, a magnetic force of the magnet is increased and the magnet and the coil can be easily inserted into the fixed body and, as a result, workability can be improved.

According to at least an embodiment of the present invention, the holder body for holding the magnet pieces and the magnet pieces are fixed to each other by the first adhesive means and the second adhesive means is disposed in the gap space, which is formed between the opposite end faces of the magnet pieces, and on the opposite end faces of the magnet pieces and thus fixing strength of the magnet is improved and falling of the magnet can be prevented.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1(a) and 1(b) are cross-sectional views showing a mechanical structure of a lens drive device in accordance with at least a first embodiment of the present invention.

FIGS. 2(a) through 2(c) are explanatory views for explaining an assembling method for a magnet to a holder body in at least the first embodiment of the present invention. FIG. 2(a) is an exploded perspective view showing the magnet and the holder body, FIG. 2(b) is a cross-sectional view where the magnet is fixed to the holder body, and FIG. 2(c) is a cross-sectional view where the magnets are adhesively bonded to each other and the magnets are adhesively bonded to the holder body.

FIG. 3 is an exploded perspective view for explaining an assembling method for the lens drive device in accordance with at least the first embodiment of the present invention.

FIGS. 4(a)-4(d) are explanatory views for explaining states where a sleeve is operated to stop at a desired position in the lens drive device in accordance with at least the first embodiment of the present invention.

FIG. 5 is a cross-sectional view showing a shape of a magnet in a lens drive device in accordance with at least a second embodiment of the present invention.

FIG. 6 is a cross-sectional view showing a shape of a magnet in a lens drive device in accordance with at least a third embodiment of the present invention.

### DETAILED DESCRIPTION OF PREFERRED EMBODIMENTS

At least an embodiment for carrying out the present invention will be described below with reference to the accompanying drawings.

### First Embodiment

### [Mechanical Structure]

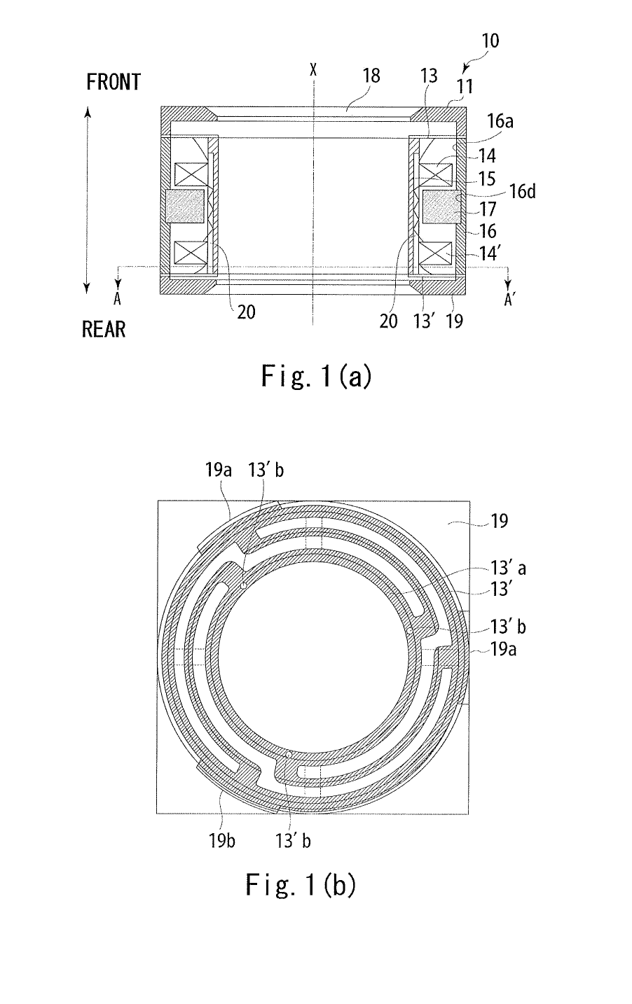

FIGS. 1(a) and 1(b) are cross-sectional views showing a mechanical structure of a lens drive device 10 in accordance with at least an embodiment of the present invention. More specifically, FIG. 1(a) is a cross-sectional view showing the lens drive device 10 which is cut in a direction of an optical axis X of a lens. FIG. 1(b) is a cross-sectional plan view showing the lens drive device 10 in the cross-sectional view of FIG. 1(a) which is cut by the alternate long and short dash line of A-K. In this embodiment, for convenience of explanation, in FIG. 1(a), an upper side is set to be a front side which is closer to an object to be photographed and a lower side is set to be a rear side which is close to a camera body.

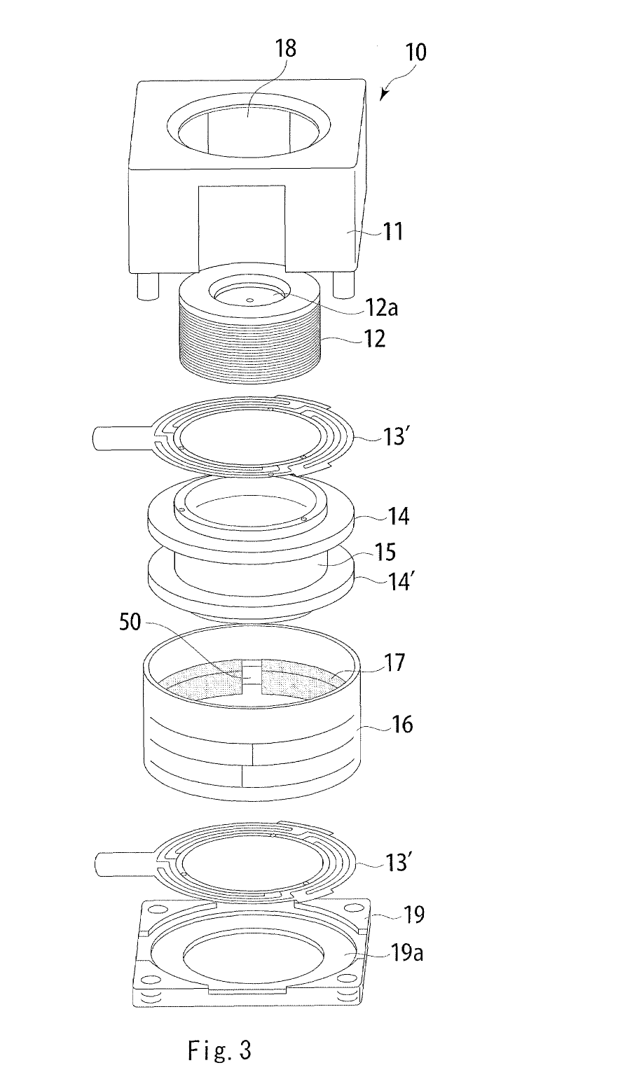

In FIGS. 1(a) and 1(b), the lens drive device 10 is principally structured of a movable lens body provided with a lens, a fixed body which supports the movable lens body so as to be movable in an optical axis X-direction of the lens, and a drive mechanism for moving the movable lens body in the optical axis X-direction. In this embodiment, the lens drive device 10 includes a cover holder 11 corresponding to a part of the fixed body and a sleeve 15 corresponding to a part of the movable lens body. A lens-barrel 12 formed in a substantially cylindrical shape in which the optical axis X is located at its center is mounted in the inside of the sleeve 15 (not shown in FIGS. 1(a) and 1(b), see FIG. 3). A lens 12a is provided in the inside of the lens-barrel 12 (see FIG. 3). The lens 12a is usually structured of plural pieces of lens which are assembled. In this embodiment, the movable lens body is structured of the lens-barrel 12, the lens 12a, the sleeve 15 and the like.

The cover holder 11 and a holder support 19 can be fitted to each other (see FIG. 3) and a yoke 16 as a cylindrical holder body is fixed by the cover holder 11 and the holder support 19. A magnet 17 formed in a roughly ring shape is fixed on an inner peripheral face of the yoke 16. In other words, the magnet 17 is fixed to the yoke 16 so as to protrude on an inner side from an inner peripheral face 16a of the yoke 16 (see FIG. 3). Further, the magnet 17 is magnetized in a direction perpendicular to the direction of the optical axis X. In this embodiment, the yoke 16 as the holder body is made of ferromagnetic substance such as a steel plate.

Two drive coils are fixed on the outer periphery of the sleeve 15. Specifically, a first coil 14 formed in a ring shape is fixed on the front side and a second coil 14′ formed in a ring shape is fixed on the rear side. In other words, the first coil 14 is disposed on the outer periphery of the sleeve 15 on the front side from the magnet 17 so as to face the magnet 17, and the second coil 14′ is disposed so that the magnet 17 is interposed in the direction of the optical axis X with respect to the first coil 14. As a result, a rear end face of the first coil 14 and a front end face of the magnet 17 face each other and a front end face of the second coil 14′ and a rear end face of the magnet 17 face each other. In this embodiment, the first coil 14 and the second coil 14′ which are fixed to the sleeve 15 are relatively moved with respect to the yoke 16 in the direction of the optical axis X.

In this embodiment, the winding numbers of the first coil 14 and the second coil 14′ are set to be equal to each other but their winding numbers may be set to be different from each other. Further, in this embodiment, a drive mechanism is structured of the first coil 14, the second coil 14′, the yoke 16 as the holder body, the magnet 17 and the like.

Magnetic flux generated from an “N”-pole of the magnet 17 returns to the magnet 17, for example, through the sleeve 15, the first coil 14 and the yoke 16. Further, magnetic flux generated from the “N”-pole of the magnet 17 returns to the magnet 17, for example, through the sleeve 15, the second coil 14′ and the yoke 16. Therefore, a magnetic circuit (magnetic path) is formed of the members such as the first coil 14, the second coil 14′, the yoke 16 and the sleeve 15. In this case, it is preferable to use magnetic material for the sleeve 15. In accordance with an embodiment, the sleeve 15 may be structured of material which does not form the magnetic circuit (magnetic path).

A distance between opposite faces of the first coil 14 and the second coil 14′ is larger than a thickness in the direction of the optical axis X of the magnet 17 and thus a space is formed between the magnet 17 and the first coil 14 (or the second coil 14′) in the direction of the optical axis X. Therefore, the sleeve 15 integrated with the first coil 14 and the second coil 14′ can be moved within a region of the space in the direction of the optical axis X. The yoke 16 is formed so that its length in the direction of the optical axis X is longer than the distance between the opposite faces of the first coil 14 and the second coil 14′. Therefore, leakage flux leaking from the magnetic path between the magnet 17 and the first coil 14 (or the second coil 14′) can be reduced and linearity between a moving amount of the sleeve 15 and an electric current supplied to the first coil 14 (and the second coil 14′) can be improved.

A circular incident aperture 18 is formed at a center on the front side of the cover holder 11 for taking a reflected light from an object to be photographed into the lens 12a (see FIG. 3). In this embodiment, the cover holder 11, the yoke 16 as the holder body, the holder support 19 and the like structure the fixed body. The yoke 16 is also used for the holder body and thus the yoke 16 is a part structuring the fixed body and, in addition, a part structuring the drive mechanism. In accordance with an embodiment, the holder body may be formed separately from the yoke 16.

The lens drive device 10 includes, as shown in FIG. 1(a), a plate spring 13 and a plate spring 13′ for regulating movement of the sleeve 15. The plate spring 13′ of these springs will be described in detail with reference to FIG. 1(b). In FIG. 1(b), the plate spring 13′ mounted on the holder support 19 is engaged with rotation preventing grooves 19a formed in the holder support 19. In this manner, the plate spring 13′ is prevented from being rotated.

The plate spring 13′ is a metal spring for supplying an electric current and a rear end of the sleeve 15 is placed on its most inside circumferential portion 13′a. The circumferential portion 13′a is formed with three terminals 13′b for energizing the second coil 14′ (see FIG. 1(b)) and an electric current can be supplied to the second coil 14′ through the terminals 13′b.

Although detailed description is omitted but, similarly to the plate spring 13′, the plate spring 13 is formed with terminals for energizing the first coil 14 and an electric current can be supplied to the first coil 14 through the terminals. In this manner, the plate spring 13 and the plate spring 13′ function as an electric wire for energization to the first coil 14 and the second coil 14′ and, as a result, an electrical circuitry of the lens drive device 10 (circuit wiring) can be simplified and the size of the entire lens drive device 10 can be reduced.

In this embodiment, the sleeve 15 is provided with an electric wire 20 for energization to the first coil 14 and the second coil 14′ (see FIG. 1(a)). In this manner, an electric current flowing through the first coil 14 and an electric current flowing through the second coil 14′ are equal to each other and thus control of the electric current becomes easy.

### [Fixing Structure of Magnet and its Fixing Method]

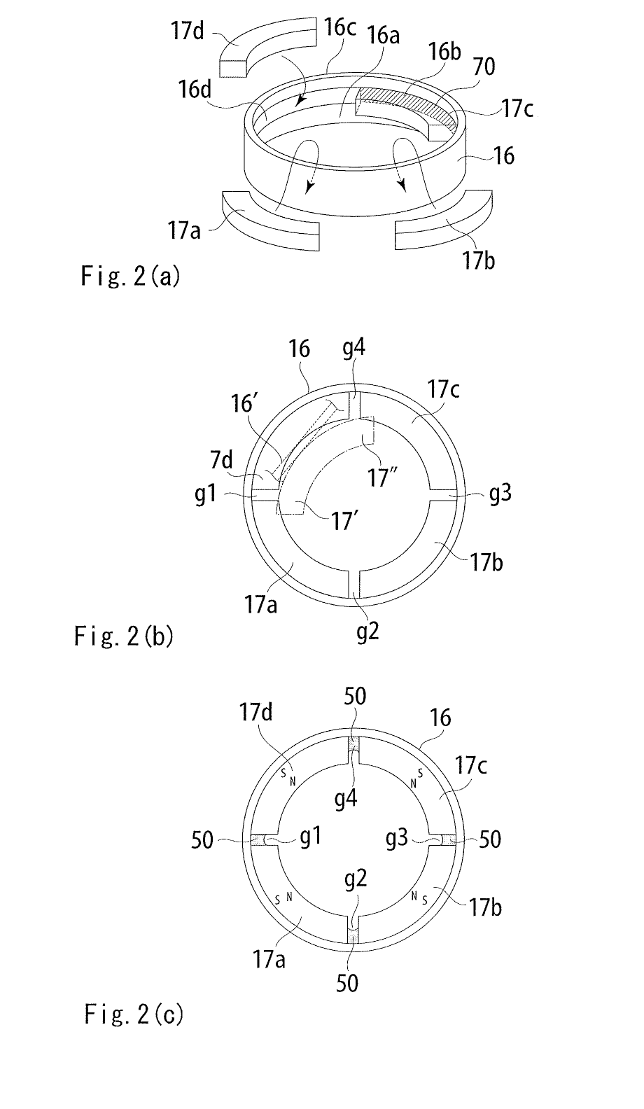

FIGS. 2(a)-2(c) are explanatory views for explaining an assembling method for the magnet to the holder body in at least an embodiment of the present invention. FIG. 2(a) is an exploded perspective view showing the magnet and the holder body, FIG. 2(b) is a cross-sectional view where the magnet is fixed to the holder body, and FIG. 2(c) is a cross-sectional view where the magnets are adhesively bonded to each other and the magnet is adhesively bonded to the holder body.

In this embodiment, the magnet 17 is a sintered body made of Neodymium and comprised of four magnet pieces 17a, 17b, 17c and 17d formed in a circular arc shape. The magnet 17 is disposed in a ring shape so that predetermined gap spaces g1 through g4 are provided between the respective magnet pieces 17a through 17d. In other words, the magnet pieces 17a through 17d are mounted on the inner peripheral face of the yoke 16 as the holder body with the predetermined gap spaces g1 through g4. In this embodiment, the respective magnet pieces 17a, 17b, 17c and 17d are structured by means of that the magnet 17 is roughly divided into four parts and they are formed in the substantially same shape and the substantially same size but the present invention is not limited to this embodiment.

The magnet 17 is divided into the magnet pieces 17a through 17d as described above and thus, even when circular shapes of the yoke 16 are different from each other due to machining variation within an error range of the yoke 16, the difference can be adjusted by the predetermined gap spaces g1 through g4. Further, the magnet pieces 17a through 17d are capable of fixing on the inner peripheral face of the yoke 16 with a satisfactory degree of accuracy. In addition, the magnet pieces 17a through 17d do not require a high degree of machining accuracy and thus cost can be reduced.

Further, the predetermined gap spaces g1 through g4 are set to be a distance so that a force by which the respective magnet pieces 17a through 17d are magnetically attracted to the yoke 16 is stronger than a repulsive force generated by adjacent magnet pieces or so that the force is not affected by the repulsive force. In other words, the respective magnet pieces 17a through 17d can be fixed to the inner peripheral face 16a of the yoke 16 by the magnetic attractive force.

The yoke 16 as the holder body is formed with a positioning part 16d for fixing the magnet 17 comprised of the magnet pieces 17a, 17b, 17c and 17d at previously determined positions on the inner peripheral face 16a. In this embodiment, a groove which is recessed toward the outer peripheral side in the radial direction is formed as the positioning part 16d. A slanted line region as shown by the notational symbol 16b indicates an adhesion position of the magnet piece 17c as an example. Further, in this embodiment, the magnet pieces 17a through 17d are mounted so as to be substantially parallel to an upper end part 16c as a reference surface of the yoke 16.

In this embodiment, a first adhesive 70 as a first adhesive means is provided between the outer peripheral faces of the magnet pieces 17a through 17d (opposite faces to the inner peripheral face 16a of the yoke 16) and the inner peripheral face 16a of the yoke 16. The first adhesive 70 is an anaerobic adhesive and, in this embodiment, an adhesive is used in which its hardness after curing is higher than a second adhesive described below. In accordance with an embodiment, the hardness of the first adhesive means may be set to be substantially equal to the hardness of the second adhesive means.

In addition, a second adhesive 50 as the second adhesive means is provided in the respective gap spaces g1 through g4. Specifically, the second adhesive 50 is provided in spaces formed between end faces of the respective magnet pieces 17a through 17d and the inner peripheral face 16a of the yoke 16, in other words, in the respective gap spaces g1 through g4. In addition, the second adhesive 50 having hardened is formed in a fillet-shape. The fillet-shape is indicated by a shape which is formed as a smooth surface at portions where the surface of the second adhesive 50 for adhesively bonding is connected, for example, with the end face of the magnet piece 17a and the end face of the magnet piece 17d.

In addition, the shore D hardness of the second adhesive 50 is set to be 70 or less and, even when an impact is applied to the respective magnet pieces 17a, 17b, 17c and 17d, the impact can be further absorbed.

In this embodiment, the hardness of the first adhesive 70 is higher than that of the second adhesive 50 but, similarly to the second adhesive 50, the first adhesive 70 is provided with a function to absorb an impact. However, the first adhesive 70 is not required to have a function to absorb an impact when the hardness of the first adhesive 70 is set to be higher than that of the second adhesive 50.

Since the second adhesive 50 is formed in a fillet-shape as described above, separation on the adhesion face between the end faces of the respective magnet pieces 17a through 17d and the inner peripheral face 16a of the yoke 16 (positioning part 16d) can be prevented. Specifically, when only the first adhesive 70 is used like a conventional example, for example, in a case that a cellular phone on which the lens drive device is mounted is dropped and an impact is applied, the yoke 16 to which the magnet 17 is adhesively bonded may be pressed toward a center direction from its circumferential portion to be distorted in an elliptic shape. The shape of the yoke 16 at this time is shown by the dotted line 16′. In this case, although the respective magnet pieces 17a through 17d and the yoke 16 are formed in a predetermined “R” shape, since the “R” of the yoke 16 is increased, as shown by the alternate long and short dash line in the drawing the end parts 17′ and 17″ in the circumferential direction of the magnet 17 may be separated from the inner peripheral face 16a of the yoke. Therefore, the second adhesive 50 is coated so as to be formed in a fillet-shape between the end faces of the respective magnet pieces 17a through 17d and the inner peripheral face 16a of the yoke 16.

Next, a fixing method for a magnet will be described below.

First, as shown in FIG. 2(a), the first adhesive 70 which is the first adhesive means is coated at the previously determined adhesion position 16b on the positioning part 16d of the yoke 16 and the magnet pieces 17a through 17d are adhesively bonded respectively. In this embodiment, the magnet pieces 17a through 17d are mounted so as to be substantially parallel to the upper end part 16c which is a reference surface of the yoke 16.

When the magnet 17 is mounted as described above, as shown by the cross-sectional view in FIG. 2(b), the magnet pieces 17a through 17d are mounted so as to have the predetermined gap spaces g1 through g4. The respective magnet pieces 17a through 17d are fixed by a magnetic attractive force with the yoke 16 and the first adhesive 70.

FIG. 2(c) is a cross-sectional view where the magnet pieces are adhesively bonded to each other and the magnet is adhesively bonded to the holder body.

The second adhesive 50 which is the second adhesive means is coated to the gap spaces g1 through g4 by using a jig such as a dispenser whose tip end is thin The second adhesive 50 is coated so as to reach the respective end faces facing each other of the adjacent magnet pieces (17a and 17b, 17b and 17c, 17c and 17d, and 17d and 17a) of the magnet pieces 17a through 17d and so as to reach the yoke 16. In other words, the second adhesive 50 is coated to fill the gap spaces g1 through g4 which are formed by a combination of the yoke 16 with the magnet pieces 17a through 17d.

Further, in this embodiment, in order to increase the adhesive strength, the respective magnet pieces 17a, 17b, 17c and 17d are adhesively bonded so that the second adhesive 50 is formed in a fillet-shape in the spaces between the end faces of the respective magnet pieces 17a, 17b, 17c and 17d and the inner peripheral face of the yoke 16 (predetermined gap spaces g1 through g4).

In order to reduce the size of the lens drive device 10, its thickness in the optical axis X-direction is reduced. On the other hand, in the drive mechanism structuring the lens drive device 10, in order to secure the more number of turns of the first coil 14 and the second coil 14′ for obtaining a predetermined driving force, its length in the radial direction is set to be substantially equal to that in the conventional example. When the thickness direction (optical axis X-direction) is reduced, adhesive area becomes small but, since the second adhesive 50 is coated together with the first adhesive 70, adhesive strength can be enhanced.

An adhesive, which is cured, for example, by UV or visible light, or silicon gel is used for the second adhesive means. When an adhesive is used, it is desirable that its Shore D hardness is 70 or less. Alternatively, when silicon gel is used, it is desirable that it is provided with a predetermined viscosity. In other words, in this embodiment, the hardness of the second adhesive is set to be lower than that of the first adhesive means.

Next, an assembling method for the lens drive device 10 will be described below.

### [Assembling Method]

FIG. 3 is an exploded perspective view for explaining an assembling method for a lens drive device in accordance with at least an embodiment of the present invention. In this embodiment, the first coil 14 and the second coil 14′ have been previously fixed to the outer periphery of the sleeve 15 and a lens-barrel 12 having the lens 12a has been previously assembled into the inside of the sleeve 15.

In FIG. 3, first, the plate spring 13′ is mounted on the holder support 19 so as to engage with the rotation preventing groove 19a formed on the holder support 19. Next, the yoke 16 to which the magnet 17 is fixed is inserted into the sleeve 15 to which the first coil 14 (or the second coil 14′) is fixed and then the second coil 14′ (or the first coil 14) is fixed to the sleeve 15. In this manner, the magnet 17 is disposed so as to be interposed between the first coil 14 and the second coil 14′ which are fixed on the outer periphery of the sleeve 15. After that, the yoke 16 into which the sleeve 15 has been assembled into its inside is fixed to the holder support 19. At this time, the rear end of the sleeve 15 is placed on the innermost circumferential portion 13′a of the plate spring 13′. Finally, the plate spring 13 is placed on the sleeve 15 so that its innermost circumferential portion is abutted with a front end of the sleeve 15 and then the cover holder 11 is engaged with the holder support 19. In this manner, the lens drive device 10 shown in FIG. 1(a) is assembled. In this embodiment, the plate spring 13 and the plate spring 13′ are formed with a tongue-shaped portion on the outer side in the radial direction, which serves as a power supply part to the coil.

### [Stop Operation]

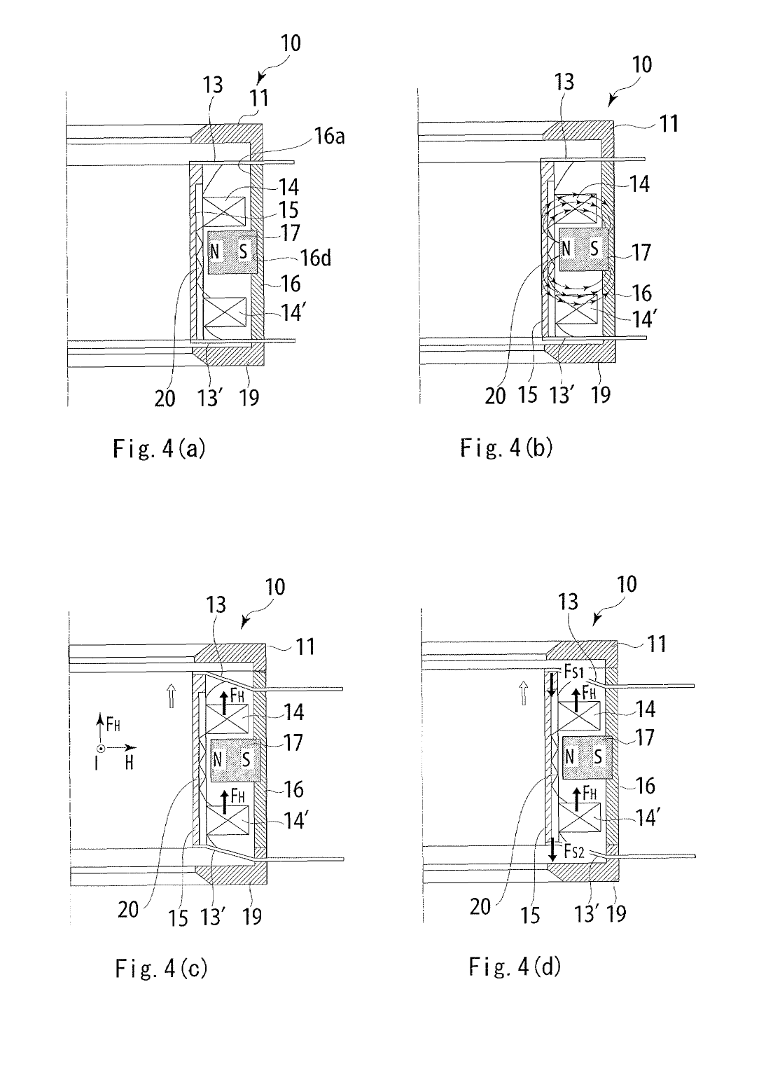

FIGS. 4(a)-4(d) are an explanatory views for explaining states where a sleeve is operated to stop at a desired position in the lens drive device. FIG. 4(a) is an explanatory view showing a mechanical structure of the right side half from the optical axis X in FIG. 1(a). Further, the magnet 17 is magnetized so that an inner side in the radial direction is an N-pole and an outer side in the radial direction is an S-pole.

In the lens drive device 10, when the first coil 14 and the second coil 14′ are not energized (state shown in FIG. 4(a)), an electromagnetic force FH does not act on the first coil 14 and the second coil 14′ and thus the sleeve 15 is held at a predetermined position by elastic forces FS1 and FS2 of the plate spring 13 and the plate spring 13′.

In FIG. 4(a), a magnetic flux from the N-pole of the magnet 17 passes the sleeve 15, the first coil 14 and then the yoke 16 in this order (see the arrow in FIG. 4(b)). When leakage flux is considered, some of the magnetic flux from the N-pole of the magnet 17 may be returned after having passed only through the first coil 14. On the other hand, another magnetic flux from the N-pole of the magnet 17 passes the sleeve 15, the second coil 14′ and then the yoke 16 in this order (see the arrow in FIG. 4(b)). When leakage flux is considered, some of the magnetic flux from the N-pole of the magnet 17 may be returned after having passed only through the second coil 14′. Therefore, the magnetic circuit (magnetic path) is formed by the members such as the first coil 14, the second coil 14′, the yoke 16 and the sleeve 15.

In this state, an electric current in the same direction is supplied to the first coil 14 and the second coil 14′. In this embodiment, as shown in FIG. 4(c), an electric current is supplied from “back side” to “front side” in the paper. As a result, the energized first coil 14 and the energized second coil 14′ which are placed in a magnetic field respectively receive an electromagnetic force FH in an upward direction (toward front side) (see the arrows in FIG. 4(c)). Therefore, the sleeve 15 to which the first coil 14 and the second coil 14′ are fixed begins to move toward the front side. In this embodiment, as described above, a wiring member 20 for energization is arranged in the sleeve 15 and the current flowing through the first coil 14 is set to be equal to the current flowing through the second coil 14′. As a result, substantially equal electromagnetic forces FH act on the first coil 14 and the second coil 14′. Further, the size of the lens drive device 10 is very small (for example, outer diameter: about 10 mm×height: about 5 mm) and thus the magnetic flux passing through the first coil 14 and the magnetic flux passing through the second coil 14′ may be considered to be substantially equal to each other.

In this case, forces (elastic force FS1, elastic force FS2) regulating a movement of the sleeve 15 respectively occur between the plate spring 13 and the front end of the sleeve 15 and between the plate spring 13′ and the rear end of the sleeve 15 (see the arrows in FIG. 4(d)). Therefore, when the electromagnetic forces FH+FH which are going to move the sleeve 15 toward the front side are balanced with the elastic forces FS 1+FS2 regulating the movement of the sleeve 15, the sleeve 15 is stopped.

When energization to the first coil 14 and the second coil 14′ is stopped, the electromagnetic forces FH do not act on the first coil 14 and the second coil 14′ and thus the sleeve 15 returns to the original position, i.e., to the position shown in FIG. 4(a) by the elastic forces FS1 and FS2 of the plate spring 13 and the plate spring 13′.

### Effects of Embodiment

According to the lens drive device in accordance with this embodiment, the yoke 16 and a plurality of the magnet pieces 17a through 17d are fixed by the first adhesive 70 and the second adhesive 50 and thus adhesive strength can be improved and the magnet 17 can be prevented from falling off from the yoke 16.

In addition, in the lens drive device 10 described in this embodiment, the second adhesive 50 provided with Shore D hardness of 70 or less is coated in the gap spaces g1 through g4 formed with a plurality of the magnet pieces 17a through 17d and the yoke 16 so as to be formed in a fillet-shape and thus adhesive strength and rigidity are increased and falling of the magnet 17 (respective magnet pieces 17a through 17d) can be prevented.

Further, in this embodiment, together with the first adhesive 70 which adhesively bonds the inner peripheral face 16a of the yoke 16 with the outer peripheral faces of the magnet pieces 17a through 17d, the second adhesive 50 formed in the fillet-shape is provided with a function for absorbing an impact occurring when the lens drive device 10 is dropped and thus the magnet 17 can be prevented from being separated from the yoke 16.

### Other Embodiments Related to First Embodiment

In this embodiment, the magnet is mounted on the inner peripheral face of the yoke as the holder body. However, the present invention is not limited to this embodiment and the magnet may be mounted on an outer peripheral face of the yoke. In other words, the holder body and the magnet, and the gap spaces between the magnet pieces are only required to be adhesively bonded by the first adhesive means and the second adhesive means. Further, the second adhesive means is not required to bridge between end faces of the magnet pieces.

In addition, the magnet 17 (magnet pieces 17a through 17d) is a sintered body made of Neodymium. However, the present invention is not limited to this embodiment and any material which can be formed along the yoke 16 may be applicable.

Further, an anaerobic adhesive is used as the first adhesive 70 but any adhesive including a UV delayed hardened adhesive and the like may be utilized when a predetermined viscosity and a predetermined adhesive strength are provided.

### Second Embodiment

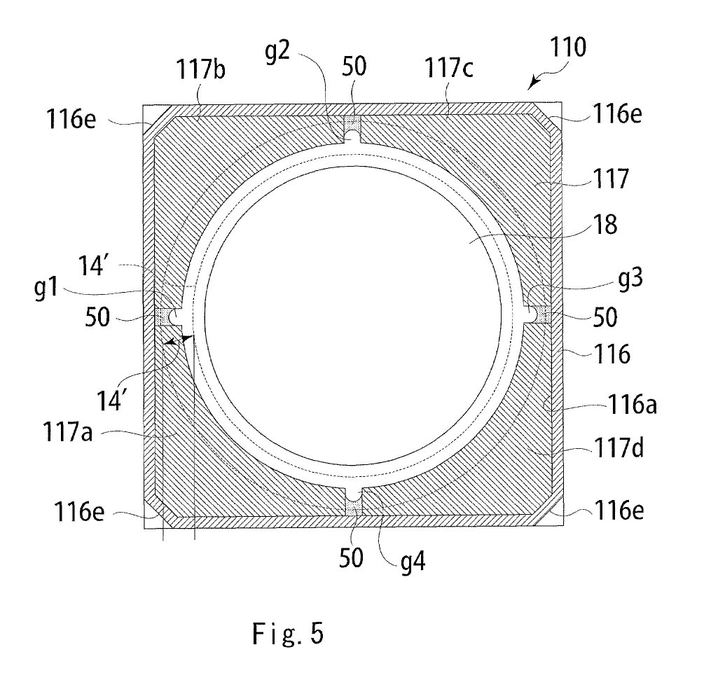

Next, FIG. 5 is a cross-sectional view showing a mechanical structure in a lens drive device 110 in accordance with at least a second embodiment of the present invention. The same notational symbols are used for the same members as the first embodiment and their detailed description is omitted. In the first embodiment, a magnet having a substantially circular ring shape is used for the magnet 17 but the present invention is not limited to this embodiment and other shape except the circular ring shape may be utilized. Specifically, in the second embodiment, as shown in FIG. 5, a magnet 117 may be formed in a shape along an inner peripheral shape of a yoke 116 as a holder body which is sandwiched by a cover holder and a holder support (not shown).

In recent years, an outer shape design of the lens drive device is in a square (square rod) shape in consideration of its positioning and assembling. Therefore, in a case that a magnet, a coil and the like are formed in a circular ring shape like the first embodiment, useless spaces occur at four corners in the lens drive device.

As a result, an outer peripheral shape of the magnet 117 is formed in a substantially square shape whose four sides are formed in a flat face and is formed along an inner peripheral face 116a of the yoke 116. Further, an inner peripheral shape of the magnet 117 is formed along an outer peripheral shape of a sleeve (not shown) in a circular ring shape (circular shape). Further, the yoke 116 is formed with chamfer parts 116e at corner parts of a square shape. In addition, the magnet 117 is divided into four pieces and, similarly to the first embodiment, gap spaces g1 through g4 are formed between the respective magnets 117.

A second adhesive 50 as a second adhesive means is coated with a predetermined quantity in the gap spaces g1, g2, g3 and g4 so as to be formed in a fillet-shape. In other words, the second adhesive 50 is coated so as to reach the respective end faces facing each other of the adjacent magnet pieces (117a and 117b, 117b and 117c, 117c and 117d, and 117d and 117a) of the magnet pieces 117a through 117d and so as to reach the yoke 116.

Further, the lens drive device 110 is structured so that the yoke 116 is formed in a substantially square shape and the magnet 117 is disposed in a space formed along a circular ring shape of a sleeve, in other words, in a space formed in a vicinity of four corners of an outer shape of the yoke 116. Thus, a magnetic force of the magnet 117 can be strengthened. Therefore, in the magnetic circuit (magnetic path), an amount of magnetic flux which passes through the sleeve, the second coil 14′ (first coil 14) and the yoke 116 in this order can be increased and thus an electromagnetic force acting on the second coil 14′ (first coil 14) can be increased even when an electric current supplied to the second coil 14′ (first coil 14) is not increased. As a result, a drive efficiency of the lens drive device 110 can be strengthened.

Further, since the amount of magnetic flux in the magnetic circuit is increased, a driving force generated by a drive mechanism can be obtained as before even when an electric current supplied to the second coil 14′ (first coil 14) is reduced and thus an energy saving efficiency can be enhanced.

Further, the magnet 117 and the yoke 116 are positioned in directions except an optical axis X-direction at respective corner parts and thus a jig or the like is not required and working efficiency can be enhanced. In this embodiment, a positioning part like a groove in a recessed shape for the magnet 117 is not formed on the inner peripheral face 116a of the yoke 116. Therefore, positioning in the optical axis X-direction is adjusted by using a jig or the like not shown.

In addition, the outer peripheral shape and the inner peripheral shape of the yoke 116 are a substantially rectangular shape and thus the magnet 117 and the first coil 14 and the second coil 14′ are easily inserted into the yoke 116 and, as a result, workability can be improved. Further, the chamfer parts 116e are formed at corner parts of the rectangular portion of the yoke 116 and thus the magnet 117 and the first coil 14 and the second coil 14′ (not shown) is easily inserted into the fixed body including the yoke 16 and, as a result, workability can be improved.

### Third Embodiment

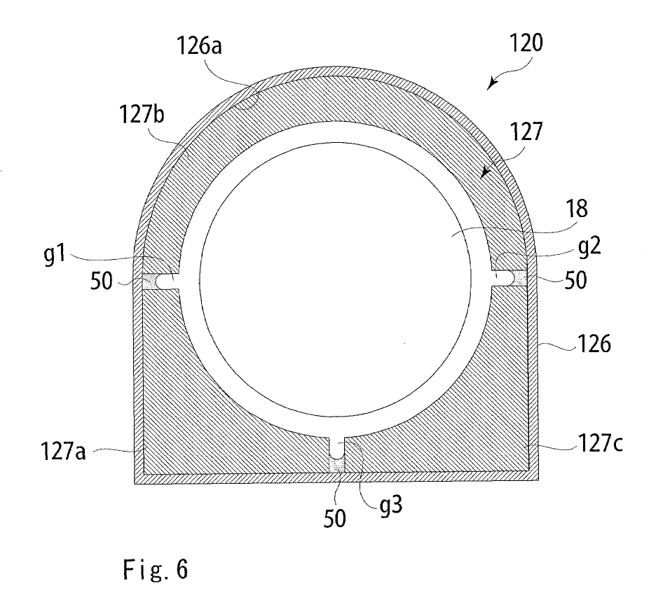

FIG. 6 is a cross-sectional plan view showing a mechanical structure of a lens drive device 120 in accordance with at least a third embodiment of the present invention.

In the lens drive device 120, the first coil 14 and the second coil 14′ are formed in a circular shape (ring shape) but an outer peripheral shape of a magnet 127 is formed of a combination of a rectangular shape including at least one flat face and a circular shape and is formed along an inner peripheral face 126a of the yoke 126. Further, an inner peripheral shape of the magnet 127 is formed in a circular ring shape (circular shape) along an outer peripheral shape of the sleeve (not shown). In addition, the magnet 127 is divided into three pieces and gap spaces g1 through g3 are formed between respective magnet pieces 127a, 127b and 127c similarly to the first embodiment. In this embodiment, positioning part like a groove formed in a recessed shape for the magnet 117 is not formed on the inner peripheral face 126a of the yoke 126. Further, chamfer parts are not formed at corner parts of a rectangular portion of the yoke 126 but chamfer parts may be formed.

A second adhesive 50 as a second adhesive means is coated with a predetermined quantity in the gap spaces g1, g2 and g3 so as to be formed in a fillet-shape. In other words, the second adhesive 50 is coated so as to reach the respective end faces facing each other of the adjacent magnet pieces (127a and 127b, 127b and 127c, 127c and 127a) of the magnet pieces 127a through 127c and so as to reach the yoke 126.

As described above, in the third embodiment, although a facing area with the second coil 14′ (first coil 14) is reduced, an adhesive area for the magnet 127 can be made larger.

Although the present invention has been shown and described with reference to specific embodiments, the present invention is not limited to the embodiments and various changes and modifications will be apparent to those skilled in the art from the teachings herein.

In the lens drive device 10 described above, the plate spring 13 and 13′ are formed in a circular ring shape (ring shape) (see FIG. 1(b)). However, for example, they may be formed in a shape along an inner peripheral shape of the yoke 16 or the holder support 19. Therefore, a plate spring can be disposed at a location which has been conventionally a wasteful space and thus a larger regulation force in comparison with a conventional case can be obtained and, as a result, stability when the lens drive device is held (or restricted) can be enhanced.

### INDUSTRIAL APPLICABILITY

The lens drive devices 10, 110 and 120 which have been described above can be mounted on various electronic equipments other than a cell phone with camera. For example, they are a PHS, a PDA, a bar code reader, a thin-type digital camera, a monitoring camera, a backward view camera for car, a door having an optical authentication function and the like.

While the description above refers to particular embodiments of the present invention, it will be understood that many modifications may be made without departing from the spirit thereof The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A lens drive device comprising:
a movable lens body which is provided with a lens; and
a drive mechanism for moving the movable lens body in an optical axis direction of the lens;
wherein the drive mechanism comprises:
a drive coil;
a magnet comprised of a plurality of magnet pieces; and
a holder body which holds the magnet;
wherein the magnet is disposed so that predetermined gap spaces are formed between opposite end faces of the plurality of the magnet pieces, and the respective magnet pieces are adhesively bonded and fixed to the holder body by using a first adhesive means, and a second adhesive means is disposed in the gap spaces and between the end faces of the magnet pieces.

2. The lens drive device according to claim 1, wherein the second adhesive means is hardened in a fillet-shape.

3. The lens drive device according to claim 1, wherein Shore D hardness of the second adhesive means is 70 or less.

4. The lens drive device according to claim 1, wherein the second adhesive means is silicon gel.

5. The lens drive device according to claim 1, wherein the second adhesive means is an adhesive which is hardened by visible light or UV light.

6. The lens drive device according to claim 1, wherein the holder body includes at least one flat face and the magnet is formed in a shape along an inner peripheral shape of the holder body.

7. The lens drive device according to claim 2, wherein Shore D hardness of the second adhesive means is 70 or less.

8. The lens drive device according to claim 2, wherein the second adhesive means is silicon gel.

9. The lens drive device according to claim 2, wherein the second adhesive means is an adhesive which is hardened by visible light or UV light.

10. The lens drive device according to claim 2, wherein the holder body includes at least one flat face and the magnet is formed in a shape along an inner peripheral shape of the holder body.

11. The lens drive device according to claim 2, wherein the fillet-shape is formed so as to connect the end faces of the magnet pieces and a connected portion of a surface of the second adhesive is formed in a smooth curved surface.

12. The lens drive device according to claim 3, wherein the first adhesive adhesively bonds between an inner peripheral face of the holder body and outer peripheral faces of the magnet pieces facing the inner peripheral face of the holder body, and hardness after being hardened of the first adhesive is higher than a hardness of the second adhesive.

13. A lens drive device comprising:
a movable lens body which is provided with a lens; and
a drive mechanism for moving the movable lens body in an optical axis direction of the lens;
wherein the drive mechanism comprises:
a drive coil;
a magnet comprised of a plurality of magnet pieces; and
a holder body which holds the magnet;
wherein the magnet is disposed so that predetermined gap spaces are formed between opposite end faces of the plurality of the magnet pieces, and the respective magnet pieces are adhesively bonded and fixed to the holder body by using a first adhesive, and a second adhesive is disposed in the gap spaces and between the end faces of the magnet pieces.
